(19) United States
(12) Patent Application Publication
(10) Pub. No.: US 2007/0147313 A1
(43) Pub. Date: Jun. 28, 2007

(54) Method for establishing a connection between a service requester (client) and a service provider (server) in a decentralized mobile wireless network

(76) Inventors: Reinhold Braam, Rhede (DE); Michael Franzen, Bocholt (DE); Wolfgang Groting, Oberhausen (DE); Gesa Lorenz, Dinslaken (DE); Sebastian Obermanns, Bocholt (DE); Malte Schmidt, Bocholt (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/580,337

(22) PCT Filed: Nov. 18, 2004
(86) PCT No.: PCT/EP04/13125

§ 371 Date: May 23, 2006

(30) Foreign Application Priority Data
Nov. 24, 2003 (DE) 103 54 877.7

(51) Int. Cl. H04Q 7/24

(52) U.S. Cl. 370/338

(57) ABSTRACT

The invention relates to method for producing a link between a person requesting a service (Client) and a service provider (Server) 3 in a decentralized mobile radio network with a service/service provider search service (Service Discovery) wherein the person requesting the service (Client) sends a Service Discovery Request in the form of a multicast message to locally adjacent stations of the decentralized mobile radio network in order to localize an as yet unknown service provider (Server) who can provide the desired service, said stations being IP routers, and said stations forward the multicast message to neighboring stations thereof before finally forwarding it to the service provider (Server) who replies with a Service Discovery Reply. The message is characterized in that the routing information of the Service Discovery Request and the Service Discovery Reply are added to the routing tables of the stations in order to retrace the way back to the person requiring the service (Client).

### CROSS REFERENCE TO RELATED APPLICATIONS

This application is the US National Stage of International Application No. PCT/EP2004/013125, filed Nov. 18, 2004 and claims the benefit thereof. The International Application claims the benefits of German application No. 10354877.7 DE filed Nov. 24, 2003, both of the applications are incorporated by reference herein in their entirety.

### FIELD OF INVENTION

The invention relates to a method for establishing a connection between a service requester (client) and a service provider (server) in a decentralized mobile wireless network with service discovery service, wherein the service requester (client), in order to locate an as yet unknown service provider (server) offering a required service, sends a service discovery request (SD-REQ) in the form of a multicast message to locally adjacent stations of the decentralized mobile wireless network which are IP routers, and these stations in turn forward the multicast message to their neighboring stations and finally to the service provider (server) which responds with a service discovery reply (SD-REP).

### BACKGROUND OF INVENTION

In future public broadband wireless networks, the routing mechanisms of ad hoc networks (decentralized networks with preferably mobile stations) will be employed. The ad hoc routing protocol is based on IP (Internet Protocol) packet switching and has the task of finding a route from the source to the destination node of a data stream within the wireless network. If no direct connection exists, the task is to select a set of routers enabling the IP packets to be transmitted. The routers forward received IP packets to the next router or to the destination station.

There are various routing protocols for ad hoc networks. The routing function is performed in different ways e.g. using AODV (Ad hoc On Demand Distance Vector Routing Protocol), DSR (Dynamic Source Routing Protocol for Mobile Ad hoc Networks), DSDV (Destination Sequence Distance Vector for Mobile Computers) protocols. The AODV protocol will now be considered by way of example.

The common feature of all the routing protocols mentioned above is that, when routing is initiated, the IP address of the receiver station is used as the input parameter. On the basis of this information, the routing protocol looks for a favorable route through the network. With increasing station mobility, the signaling of the routing protocol messages is largely responsible for the so-called signaling overhead of telecommunications. In the case of the reactive routing protocols such as AODV, route request (R-REQ) messages are multicast over the entire radio network if a route is as yet unknown or obsolete.

There are many different situations in which the address of a destination station is initially unknown, i.e. there is no input information for routing. This is the case, for example, when the mobile end customer wishes to make contact with a station providing a particular service without the computer name or IP address being known to him. Examples of this include requesting locality-related information, requesting local weather information or locating an ATM in the vicinity.

Searching for a service provider (service discovery) can be performed centrally using a “directory service” or on a decentralized basis. In the decentralized case, the service requester (client) sends a “service discovery request (SD-REQ)” message to all the stations within a selected range. The stations offering the relevant service (servers) respond accordingly. The response is then known as the “service discovery reply (SD-REP)” message. The SD-REQ message is a multicast message which reaches all the stations in a geographical area. Each station of the ad hoc network forwards the multicast message to its neighboring stations. Server stations reply with a detailed description of the requested service in the SD-REP message.

Advantageously the reply from a server now follows the route taken shortly before by the “service discovery” message. Whereas in the case of the AODV routing protocol a corresponding behavior exists in principle, it is not provided, however, for the SD-REQ and SD-REP messages. As routing tables in the routers are only adapted for using the AODV protocol, but not for forwarding service discovery protocol messages, at present a route between the relevant stations still has to be found after service discovery.

The following sequence would have to be followed under the current definition of the ad hoc routing protocol:
The client multicasts an SD-REQ message.
At each server offering the service, routing to the service requester is initiated, i.e. each server multicasts R-REQ messages in order to create a route to the client.
The client responds with R-REP.
The path between server and client now exists and the server can reply with SD-REP.
The client can now, if required, select a server and establish a connection to said server in order to make use of the required service or to obtain further information.

Another solution for avoiding multicast messages for service discovery is for servers to register their services with a central server. Clients would then first contact this central server in order to determine the IP addresses of the servers providing the required service. If a client has now selected a server, it also knows its IP address, and can then send the normal R-REQ to determine a route to the server.

The disadvantage of the second solution is that one or more server databases must be set up. The addresses of the stations must be somehow made known. In addition, the client station still has to send multicast messages in order to determine the route to the server database and, if required, the route to the server.

### SUMMARY OF INVENTION

An object of the invention is therefore to find a method for establishing the connection between a service requester (client) and a service provider (server) in a decentralized mobile wireless network with service discovery service, which minimizes the signaling overhead problem.

These objects of the invention are achieved by the method having the features set forth in the independent claims. Advantageous further developments of the invention are the subject matter of dependent claims.

The inventors have identified that it is possible to minimize the signaling overhead if the multicast message sent by the service requester (client), the routing tables used in the routers for locating the service provider (server), is also provided with routing information to the service requester (client).

According to this inventive concept, the inventors propose to improve the method known per se for establishing a connection between a service requester (client) and a service provider (server) in a decentralized mobile wireless network with service discovery service, wherein the service requester (client), in order to locate an as yet unknown service provider (server) offering a required service, sends a service discovery request (SD-REQ) in the form of a multicast message to locally adjacent stations of the decentralized mobile wireless network which are IP routers, and these stations in turn forward the multicast message to their neighboring stations and finally to the service provider (server) which responds with a service discovery reply (SD-REP), such that the routing information of the service discovery request and its service discovery reply is added to the routing tables of the stations for tracing the route back to the service requester (client).

This enables the route request (R-REQ) hitherto required from the service provider to be eliminated, thereby considerably reducing the signaling overhead in the mobile wireless network.

In a particular embodiment of the method, the service discovery request (SD-REQ) of the at least one service requester (client) can be expanded to include elements of a route request (R-REQ) of the at least one service provider (server).

In the case of the R-REQ of the AODV protocol these would be all the elements apart from those relating to the destination address, i.e. “D”, “G”, “Destination IP Address” and “Destination Sequence Number”.

In a particular embodiment, the service discovery reply (SD-REP) of the at least one service provider (server) is expanded to include all the elements of a route reply (R-REP) of the at least one service requester (client).

In the case of the AODV protocol, each station receiving these SD-REQ and SD-REP messages can update their internal routing tables on the basis of the additional information elements, so that a second explicit routing can be dispensed with.

It is advantageous if preferably an AODV or a DSR protocol is used as the routing protocol which is incorporated in the service discovery request and in the service discovery reply (SD-REP).

These routing protocols belong to the category of reactive routing protocols, by means of which a changing or obsolete route can be easily updated.

Alternatively it is advantageous if the routing protocol, preferably AODV or DSR, is expanded such that, on receipt of the expanded SD-REQ and SD-REP messages, it updates the local routing tables accordingly with the route information.

### BRIEF DESCRIPTION OF THE DRAWINGS

The invention will now be described with reference to preferred embodiments with the aid of FIGS. 1 to 6 in which the following reference numerals are used:

1: service requester (client)/station of the service requester (client); 2: other stations; 3: service provider (server)/station of the service provider (server); 4: service discovery request; 4a: service discovery request with incorporated routing information elements; 5: route request; 6: route reply; 7: service discovery reply; 7a: service discovery reply with incorporated routing information elements; 8: ad hoc network.

In detail:

FIG. 1: shows an ad hoc network in which a client sends out a service discovery request in the form of a multicast message;

FIG. 2: shows an ad hoc network from FIG. 1 in which two servers send out a route request to the client likewise in the form of a multicast message in each case;

FIG. 3: shows an ad hoc network from FIGS. 1 and 2 in which the client sends a reply to the route request back to the servers;

FIG. 4: shows an ad hoc network from FIGS. 1 to 3 in which the servers provide the required service to the client;

FIG. 5: shows an ad hoc network in which a client sends out a service discovery request in the form of a special multicast message;

FIG. 6: shows an ad hoc network from FIG. 5 in which two servers provide the required service to the client.

### DETAILED DESCRIPTION OF INVENTION

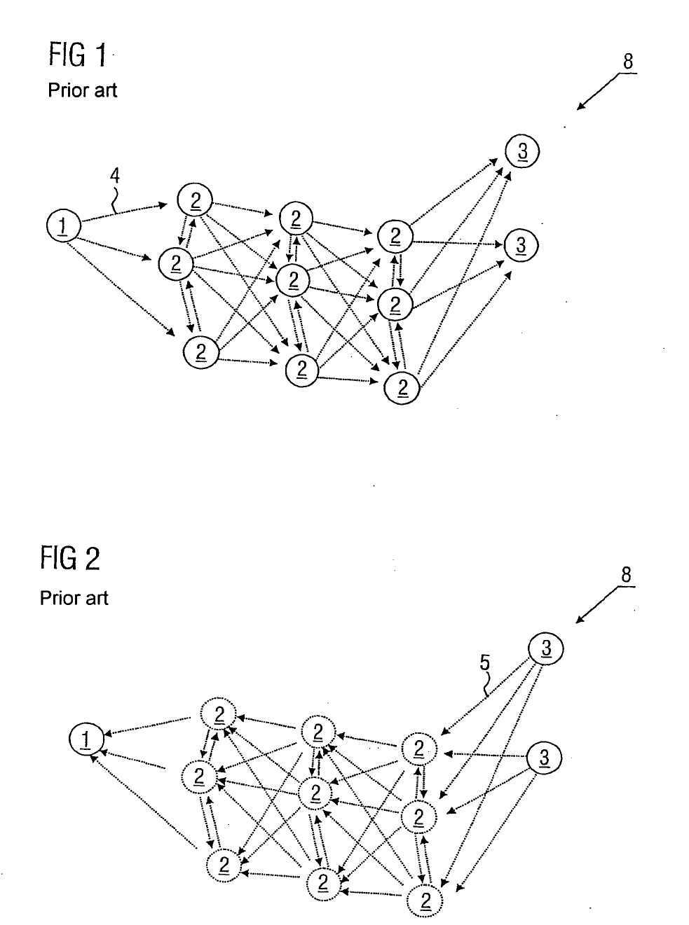

FIGS. 1 to 4 show the known method for establishing a connection between a service requester (client) 1 and a service provider (server) 3 in an ad hoc network 8. For the sake of clarity, the various steps are shown separately in FIGS. 1 to 4. In the version illustrated, the ad hoc network 8 consists of a service requester (client) 1 who wishes to call up a particular service from the network 8. This ad hoc network 8 additionally comprises a plurality of stations 2 which may also be mobile and provide various services. All the stations of the ad hoc network 8 are routers and can create connections to other stations of the ad hoc network 8 via the routing protocol used. The two special stations providing the service required by the service requester (client) 1 have been denoted by the reference numeral 3. These are then designated as service providers (servers) 3. The Figures show the following:

FIG. 1 shows how the service requester (client) 1 requiring a service such as weather data for a particular region proceeds in order to obtain the service. As the server address/IP address of the service provider (server) 3 able to provide the weather data is generally not known to the service requester (client) 1, the service requester (client) 1 will send a service discovery request 4 into the ad hoc network 8. The service discovery request 4 (dotted arrows) is transmitted by the service requester (client) 1 generally as a multicast or broadcast message to geographically adjacent stations 2. This multicast or broadcast message is forwarded by the stations 2 to their neighboring stations 2 until the right service provider(s) (server(s)) 3 is/are also reached. The distribution of all the messages mentioned here and in particular the “flooding” of the ad hoc network 8 with these messages is termed the signaling overhead. The two service providers (servers) 3 only receive the service discovery request 4 of the service requester (client) 1. The route or path on which this service discovery request 4 has come from the service requester (client) 1 to the service provider (server) 3 cannot be retraced under the service discovery service.

FIG. 2 now shows how the two service providers (servers) 3 locate the service requester (client) 1. The two service providers (servers) 3 send a route request 5 in the form of a multicast message to their locally adjacent stations 2. The route request 5 is forwarded, similarly to the service discovery request 4 from the service requester (client) 1 from FIG. 1, from station 2 to station 2 and finally to the service requester (client) 1. However, in contrast to the service discovery request 4, in the case of the route request 5, the route or path of the sender, i.e. of the two service providers (servers) 3, is made known. Thus, on receiving AODV protocol route request messages 5, the stations 2 adapt their routing tables. This “route marking” is indicated by the dotted circles of the stations 2. This step in which the service provider (server) 3 looks for the route to the service requester (client) 1 also involves flooding the network on the assumption that a route to station 1 of the service requester (client) is still unknown.

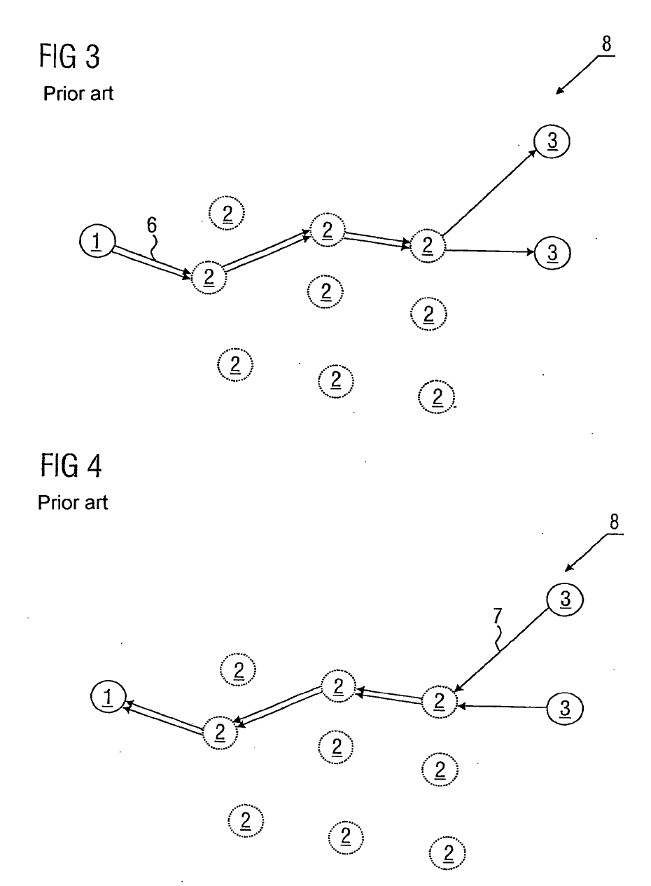

FIG. 3 shows how the service requester (client) 1 replies to the route request 5 of the two service providers (servers) 3. The service requester (client) 1 can now retrace the routes/paths over which the route request 5 of the two service providers (servers) 3 has reached him. The service requester (client) 1 sends a route reply 6 in response to each route request of the two service providers (servers) 3, e.g. on the route/path taken by the associated route request. This route reply 6 is symbolized by a solid arrow to denote that the route/path is known.

FIG. 4 shows how the two service providers (servers) 3 transmit their service description to the service requester (client) 1 on the determined route/path in the form of a service discovery reply 7. The service requester (client) 1 can now, for example, select which service provider (server) 3 to use.

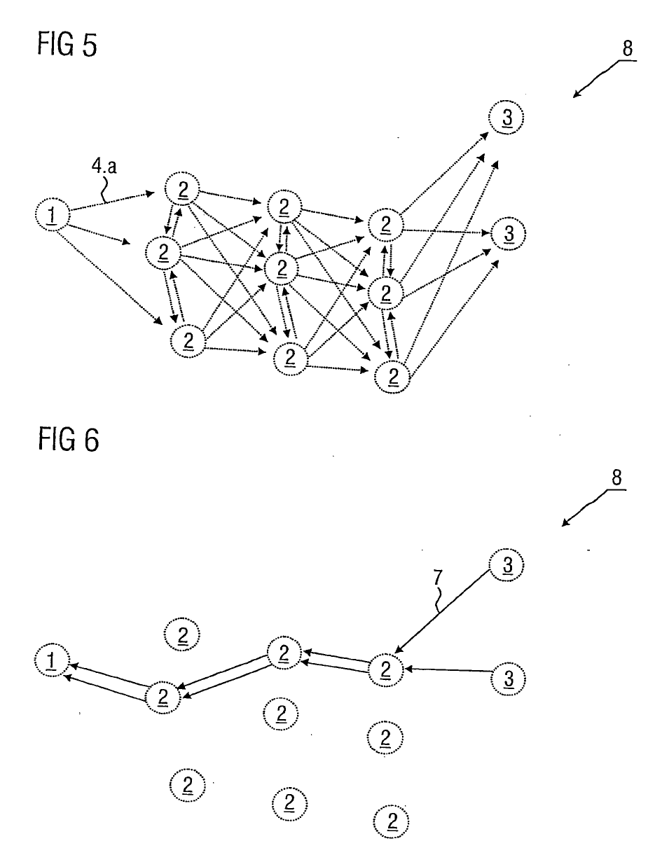

The method explained with reference to FIGS. 1 to 4 highlights the complexity of localization in the ad hoc network 8. For example, FIGS. 1 and 2 specifically show the effect of the signaling overhead. However, it is particularly the “flooding” of the ad hoc network 8 with too many messages that is to be avoided. To this end, FIGS. 5 and 6 describe a new method for establishing the connection between a service requester (client) and a service provider (server) which at least reduces the signaling overhead.

FIG. 5 shows the same ad hoc network 8 as in FIGS. 1 to 4. Analogously to FIG. 1, the service requester (client) 1 seeking an as yet unknown service provider (server) 3 offering a required service sends a multicast message to locally adjacent stations 2. In contrast to FIG. 1 this multicast message consists of a service discovery request 4a incorporating information elements of the route request. By means of the incorporated routing message, the routing tables are adapted by the extended routing protocol when this multicast message is forwarded from station 2 to adjacent station 2. Through the adapting of the routing tables, the route/path to the service requester (client) 1 can be traced back. This “route/path marking” is indicated by the dotted circles of the stations 2. It should be mentioned at this point that the stations 1 and 3, i.e. the service requester (client) and the two service providers (servers), are also routers. This means that they too generate, send and receive, and process routing protocol messages and behave according to the rules of the routing protocol. In particular, they also have routing tables. For this reason the stations 1 and 3 are also shown by dotted circles in FIGS. 5 and 6.

FIG. 6 shows how the two service providers (servers) 3 transmit their service description to the service requester (client) 1 on the now known route/path in the form of a service discovery reply 7a. In contrast to FIG. 4, this message consists of a service discovery reply 7a into which all the information elements of the route reply are incorporated. By means of the incorporated routing message the routing tables are adapted by the extended routing protocol when this message is forwarded from the station 2 to adjacent station 2. Through the adapting of the routing tables, the route/path can be traced back to the service provider (server) 3. This “route/path marking” is indicated by the dotted circles of the stations 2. The service requester (client) 1 can now, for example, select which service provider (server) 3 to use and, for example, set up a data connection to one of them without further routing.

The advantage of this new method is that the signaling overhead incurred by the transmission of route requests from the service provider (server) 3 to the service requester (client) 1 in the form of multicast messages, as shown in FIG. 2, can be eliminated.

All in all, there is provided a new method for establishing a connection between a service requester (client) and a service provider (server) in a decentralized mobile wireless network with service discovery service, preferably in an ad hoc mobile wireless network or a mobile wireless network using reactive ad hoc network protocols, said method requiring fewer multicast messages and therefore minimizing the signaling overhead problem.

Obviously the abovementioned features of the invention can be used not only in the combination specified but also in other combinations or on their own, without departing from the scope of the invention.

1.-5. (canceled)

6. A method for establishing a connection between a service requester and a service provider in a decentralized mobile wireless network comprising a plurality of IP routers, each router comprising a routing table, the method comprising:
sending a service discovery request message towards a service provider via the plurality of IP routers;
receiving the request message by each router;
adding, at each router, routing information pertaining to the received request message in the routing table;
receiving the request message by the provider;
responding by the provider with a service discovery reply in response to the service discover request message; and
adding, at a portion of the plurality of IP routers, routing information pertaining to the corresponding reply messages to the routing table.

7. The method according to claim 6, wherein the request message include an element of a route request of a service provider.

8. The method according to claim 7, wherein the reply message includes all the elements of a route reply of the service requester.

9. The method according to claim 6, wherein the request and reply messages are in accordance to a Ad hoc On Demand Distance Vector Routing Protocol or a Dynamic Source Routing Protocol for Mobile Ad hoc Networks.

10. The method according to claim 9, wherein the protocol of the request and reply message is extended such that on receipt of the expanded messages the routing tables are updated with routing information.

11. A method for establishing a connection between a service requester and a service provider in a decentralized mobile wireless network comprising a plurality of IP routers, each router comprising a routing table, the method comprising:
multicasting a service discovery request message towards a service provider via the plurality of IP routers, wherein the network is flooded with the request message from the multicasting;
receiving the request message by each router;
adding, at each router, routing information pertaining to the received request message in the routing table;
receiving the request message by the provider;
responding by the provider with a service discovery reply in direct response to the service discover request message, wherein the network is not flooded with the reply message;
receiving the reply message by a portion of the plurality of IP routers; and
adding, at the portion of the plurality of IP routers, routing information pertaining to the corresponding reply message to the routing table,
whereby an over-head incurred in the network by multicasting a route request from the provider to the requester is avoided.

12. The method according to claim 11, wherein the request message includes an indicator indicating to the receiving routers to add routing information pertaining to the received request message.

13. The method according to claim 11, wherein the reply message includes an indicator indicating to the receiving routers to add routing information pertaining to the received reply message.

14. The method according to claim 11, wherein the request and reply messages are in accordance to a Ad hoc On Demand Distance Vector Routing Protocol or a Dynamic Source Routing Protocol for Mobile Ad hoc Networks.

15. The method according to claim 11, wherein the portion of the routers is determined via a route/path determined from multicasting.

16. A decentralized mobile wireless network system, comprising:
a network service that is available to a service requester;
a plurality of IP routers each having a routing table;
a service discovery request message that includes a first routing indicator and information pertaining to the service,
wherein the request message is multicasted from the requester, thereby flooding the network, and
wherein each router receives the request message and updates the routing table with routing information pertaining to the received request message when the request message includes the first routing indicator;
a plurality of service providers receive the request message; and
a service discovery reply that includes a second routing indicator,
wherein the reply is sent by a provider that receives the request message and that provides the service, the reply is sent in direct response to the service discover request message,
wherein the network is not flooded with the reply message, and
wherein the reply message is received by a portion of the plurality of IP routers and the routing table at the portion of routers is updated with information pertaining to the corresponding reply message when the reply message includes the second routing indicator, and
wherein a connection between the requester and the provider providing the service is establishing in the network.

17. The method according to claim 16, wherein the portion of the routers is determined via a route/path determined from multicasting.

18. The method according to claim 16, wherein the request and reply messages are in accordance to a Ad hoc On Demand Distance Vector Routing Protocol or a Dynamic Source Routing Protocol for Mobile Ad hoc Networks.
